(19) United States
(12) Patent Application Publication
(10) Pub. No.: US 2015/0370105 A1
(43) Pub. Date: Dec. 24, 2015

(54) LIQUID CRYSTAL DISPLAY INCLUDING LIGHT BLOCKING MEMBER OVERLAPPING SPACER

(71) Applicant: Samsung Display Co.,Ltd., Yongin-City (KR)

(72) Inventors: Sung Jin HONG, Seoul (KR); Dong Wook KIM, Seoul (KR); Hyun Wuk KIM, Yongin-si (KR); Ock Soo SON, Seoul (KR); Young Gu KANG, Hwaseong-si (KR); Eun Je JANG, Hwaseong-si (KR)

(21) Appl. No.: 14/717,111

(22) Filed: May 20, 2015

(30) Foreign Application Priority Data
Jun. 20, 2014 (KR) 10-2014-0076076

(51) Int. Cl. G02F 1/1339; G02F 1/1343; G02F 1/1333; G02F 1/1337; G02F 1/1368; G02F 1/1362

(52) U.S. Cl. CPC G02F 1/1339; G02F 1/1368; G02F 1/136286; G02F 1/136209; G02F 1/133345; G02F 1/1337; G02F 1/13439; G02F 2001/136222

(57) ABSTRACT

A liquid crystal display includes: a first substrate; a gate line and a data line on the first substrate; a first electrode and a second electrode on the first substrate and overlapping each other with a first insulating layer therebetween; a light blocking extension on the first substrate; a spacer on the light blocking extension; and a first alignment layer on the spacer and having an alignment direction. A plane form of the light blocking extension includes a side elongated parallel to the alignment direction.

This application claims priority to Korean Patent Application No. 10-2014-0076076 filed on Jun. 20, 2014, and all the benefits accruing therefrom under 35 U.S.C. §119, the entire contents of which are incorporated herein by reference.

### BACKGROUND

(a) Field

The invention relates to a liquid crystal display.

(b) Description of the Related Art

A liquid crystal display is one among flat panel displays, and is a display device that adjusts an amount of transmitted light by applying a voltage to an electrode and rearranging liquid crystal molecules of a liquid crystal layer.

A liquid crystal display, in which a pixel electrode and a common electrode are disposed on one display substrate of a single display panel among two display panels, has attracted attention as a method of improving transmittance and implementing a wide viewing angle in a display device. An alignment layer is disposed on an internal surface of one or more display panel of the liquid crystal display, and the alignment layer has a predetermined alignment direction to control a pretilt direction of liquid crystal molecules.

### SUMMARY

In a liquid crystal display, to maintain a distance between two display panels, between which a liquid crystal layer of the liquid crystal display is injected, a spacer is used. The liquid crystal molecules that are provided near the spacer are inclined in a direction that is different from the alignment layer predetermined alignment direction because of the spacer, thereby undesirably generating a leakage of light. Therefore, an improved liquid crystal display in which liquid crystal molecules that are provided near the spacer are inclined in a direction that is not different from the alignment layer pretilt direction is desired.

One or more exemplary embodiment provides a liquid crystal display in which a transmittance is increased, a wide viewing angle is improved, and leakage of light that may occur near a spacer is reduced or effectively prevented. An exemplary embodiment of the invention provides a liquid crystal display including: a first substrate; a gate line and a data line on the first substrate; a first electrode and a second electrode on the first substrate and overlapping each other with a first insulating layer therebetween; a light blocking extension on the first substrate; a spacer on the light blocking extension; and a first alignment layer on the spacer and having an alignment direction. A plane form of the light blocking extension includes a side elongated parallel to the alignment direction.

The light blocking extension may have a quadrangular plane form.

The liquid crystal display may include a plurality of pixel areas, and the light blocking extension may be extended to overlap four adjacent pixel areas.

The light blocking extension may overlap a red pixel area and a blue pixel area.

The liquid crystal display may further include a first light blocking member and a second light blocking member on the first substrate. The first light blocking member may be elongated to overlap the data line, and the second light blocking member may be elongated to overlap the gate line.

The second light blocking member may include the light blocking extension.

The light blocking extension may be wider than a maximum dimension of the spacer.

The liquid crystal display may further include a color filter between the first substrate and the first electrode, and between the first substrate and the second electrode.

The first electrode may have a planar shape in a pixel area, the second electrode may include a plurality of branch electrodes in the pixel area, and the second electrode branch electrodes may overlap the planar shape first electrode in the pixel area.

According to one or more exemplary embodiment of the invention, transmittance of the liquid crystal display is increased, a relatively wide viewing angle is provided, and the leakage of light that may occur near the spacer is reduced or effectively prevented.

### BRIEF DESCRIPTION OF THE DRAWINGS

The above and other advantages and features of this disclosure will become more apparent by describing in further detail exemplary embodiments thereof with reference to the accompanying drawings, in which:

FIG. 1 shows a top plan view of an exemplary embodiment of a plurality of pixels of a liquid crystal display according to the invention.

FIG. 2 shows a plan view of an enlarged portion of the liquid crystal display of FIG. 1.

FIG. 3 shows a plan view of an exemplary embodiment of one pixel of a liquid crystal display according to the invention.

FIG. 4 shows a cross-sectional view of the liquid crystal display of FIG. 3 with respect to line IV-IV.

FIG. 5 shows a cross-sectional view of the liquid crystal display of FIG. 3 with respect to line V-V.

FIG. 6 and FIG. 7 respectively show plan views of exemplary embodiments of a light blocking extension with respect to a spacer of a liquid crystal display according to the invention.

FIG. 8 and FIG. 9 are scanning electron microscope photographs respectively showing a result of experimental examples of light leakage in a conventional liquid crystal display and in an exemplary embodiment of liquid crystal display according to the invention.

### DETAILED DESCRIPTION

The invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the invention.

In the drawings, the thickness of layers, films, panels, regions, etc., are exaggerated for clarity. Like reference numerals designate like elements throughout the specification.

It will be understood that when an element such as a layer, film, region, or substrate is referred to as being “on” another element, it can be directly on the other element or intervening elements may also be present. In contrast, when lo an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

A liquid crystal display of the invention will now be described with lo reference to accompanying drawings.

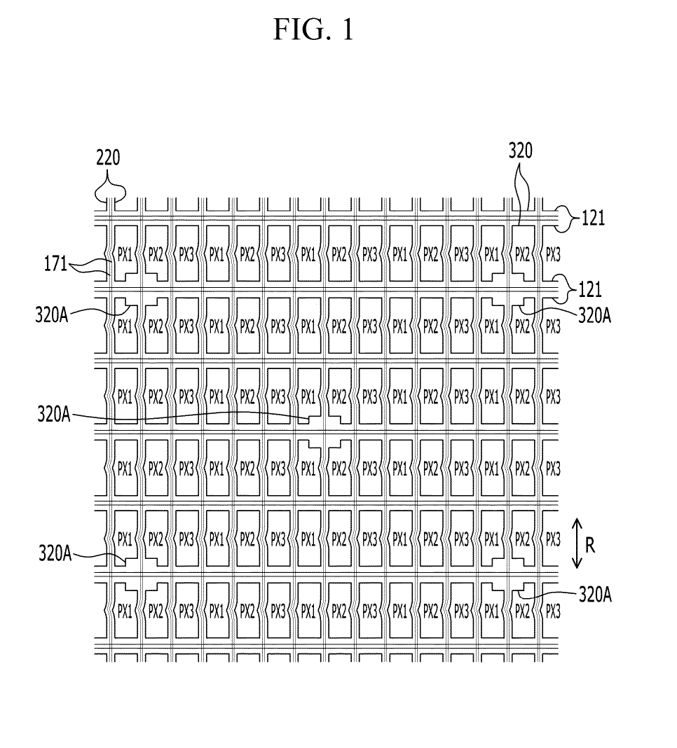

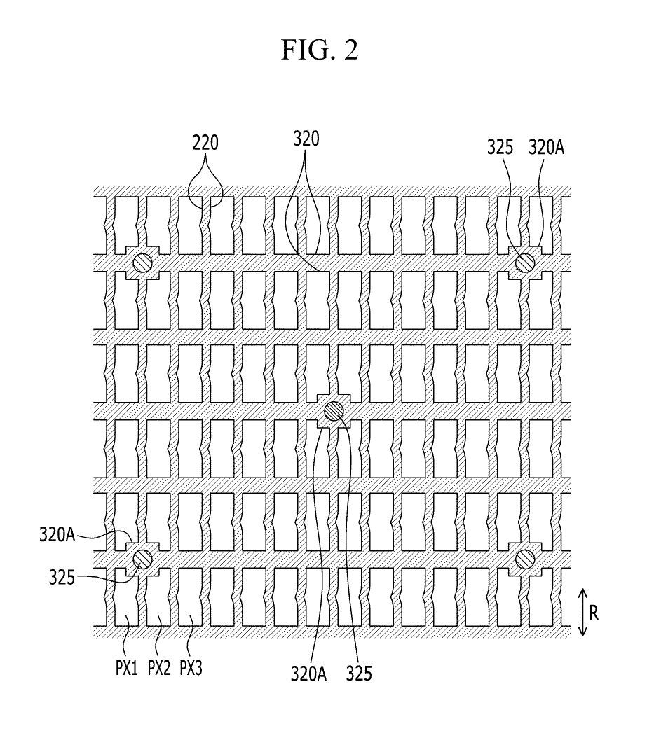

An exemplary embodiment of a liquid crystal display according to the invention will now be described with reference to FIG. 1 and FIG. 2. FIG. 1 shows a plan view of an exemplary embodiment of a plurality of pixels of a liquid crystal display according to the invention. FIG. 2 shows a plan view of an enlarged portion of the liquid crystal display of FIG. 1.

Referring to FIG. 1, the liquid crystal display includes a plurality of pixel areas PX1, PX2 and PX3 including a plurality of opening regions respectively defined therein. In an exemplary embodiment, the pixel areas PX1, PX2 and PX3 respectively represent a region surrounded by two adjacent gate lines 121 and two adjacent data lines 171, but the invention is not limited thereto.

The pixel areas PX1, PX2 and PX3 include a first pixel PX1, a second pixel PX2 and a third pixel PX3 for expressing different colors.

Referring to FIG. 1 and FIG. 2, the pixel areas PX1, PX2 and PX3 are surrounded by a collective light blocking member. The collective light blocking member includes portions such as a first light blocking member 220 elongated to overlap a data line 171 and a second light blocking member 320 elongated to overlap a gate line 121. The first light blocking member 220 and the second light blocking member 320 may be in a same layer or in different layers of the liquid crystal display, and may overlap each other. In an exemplary embodiment of manufacturing the liquid crystal display, the first light blocking member 220 and the second light blocking member 320 may be formed from a same material to be disposed in the same layer or in different layers of the liquid crystal display, and may overlap each other.

The second light blocking member 320 includes a light blocking extension 320A disposed on a position overlapping a spacer 325. The light blocking extension 320A is disposed to overlap a portion of the pixel areas PX1, PX2 and PX3. The pixel areas PX1, PX2 and PX3 may have a planar area larger than that of a region defined by the collective surrounding light blocking member, such that the light blocking extension 320A overlaps a portion of the pixel areas PX1, PX2 and PX3.

The light blocking extension 320A is provided to overlap four pixel areas provided at two adjacent pixel columns and at two adjacent pixel rows. The light blocking extension 320A can be provided at a pixel for expressing red and a pixel for expressing blue.

A plane form or shape of the light blocking extension 320A is substantially quadrangular including two first sides that are parallel to the gate line 121 and two second sides that are substantially orthogonal to the first sides. The first and second sides of the light blocking extension 320a may meet to form an angular corner, but the invention is not limited thereto. In an exemplary embodiment, the four corners of the light blocking extension 320A may be rounded. Further, the plane form of the light blocking extension 320A can include two first sides that are parallel to the gate line 121 or two second sides that are orthogonal to the gate line 121.

An alignment direction (R) shown in FIG. 1 and FIG. 2 represents an initially aligned direction of the alignment layer of the liquid crystal display. The second side of the light blocking extension 320A is substantially parallel to the alignment direction (R). The light blocking extension 320A includes at least one side that is substantially parallel to the alignment direction (R).

The first side and the second side of the light blocking extension 320A are longer than a maximum dimension (e.g., a width) of the spacer 325, taken in the first side direction and the second side direction, respectively.

As described above, leakage of light caused by irregular movement of the liquid crystal molecules occurring near the spacer 325 can be reduced or effectively prevented by disposing the light blocking extension 320A overlapping the spacer 325.

Further, an edge of the light blocking extension 320A is parallel or orthogonal to the alignment direction (R) of the liquid crystal display by disposing the light blocking extension 320A to have a plane form of a substantial quadrangle. Therefore, leakage of light induced by irregular movement of the liquid crystal molecules that may occur around the light blocking extension 320A can be reduced or effectively prevented.

A liquid crystal display will now be further described with reference to FIG.

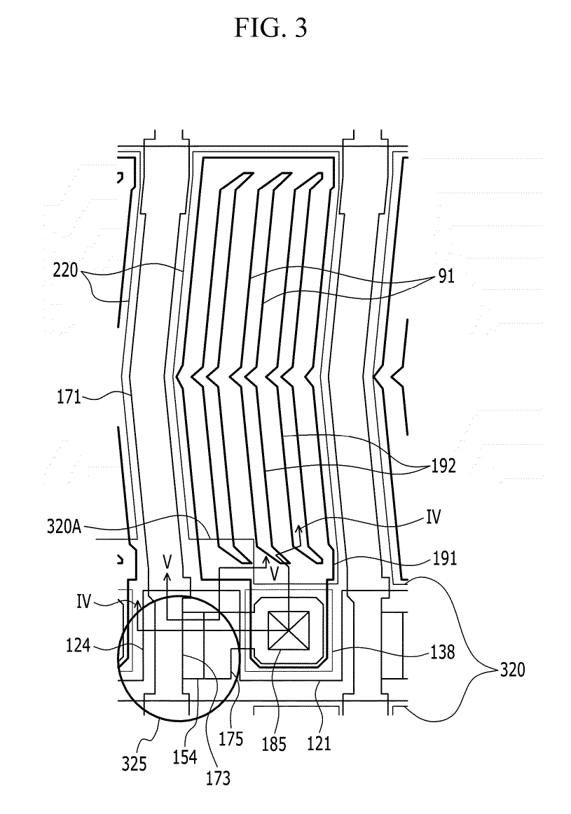

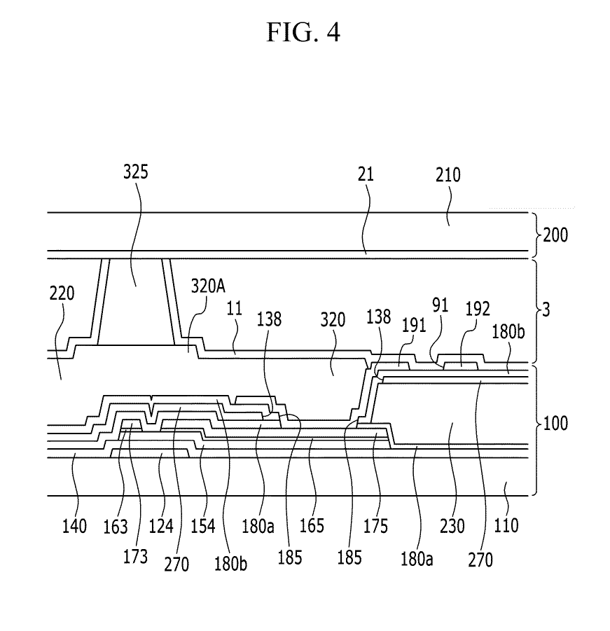

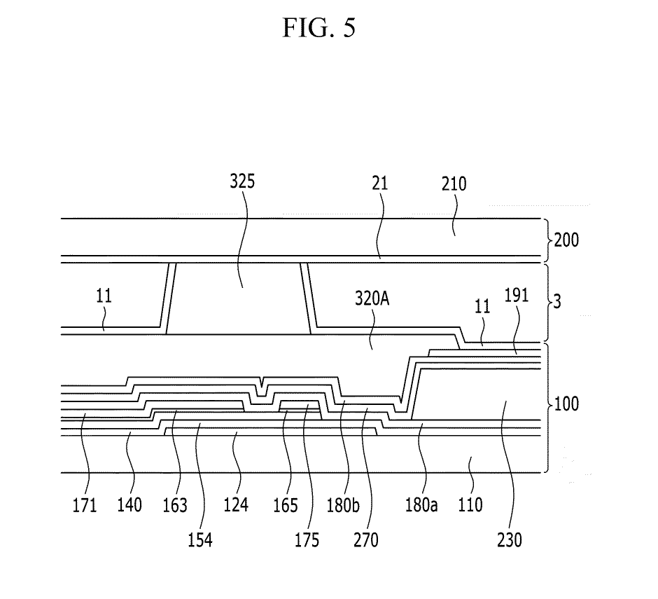

3 to FIG. 5. FIG. 3 shows a plan view of an exemplary embodiment of one pixel of a liquid crystal display according to the invention. FIG. 4 shows a cross-sectional view of the liquid crystal display of FIG. 3 with respect to line IV-IV. FIG. 5 shows a cross-sectional view of the liquid crystal display of FIG. 3 with respect to line V-V.

Referring to FIG. 3 to FIG. 5, the liquid crystal display includes a lower display panel 100 and an upper display panel 200 facing each other, and a liquid crystal layer 3 injected therebetween. Each of the lower and upper display panels 100 and 200 includes defined therein, a display area at which an image is displayed, and a non-display area at which an image is not displayed. Similarly, a pixel area may include a non-display region corresponding to the light blocking member, and a display region corresponding to a remaining portion of the pixel area excluding the non-display region, but the invention is not limited thereto.

The lower display panel 100 will now be described.

A gate conductor including a gate line 121 is disposed on a first substrate 110 including of transparent glass or plastic.

The gate line 121 includes a gate electrode 124 extended from an elongated portion thereof, and a wide end portion (not shown) for contact with another layer or an external driving circuit. The gate line 121 may include an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), titanium (Ti), and the like. The gate line may have a single layer structure, but the invention is not limited thereto. In an exemplary embodiment, the gate line 121 may have a multilayer structure including at least two conductive layers with different physical properties.

A gate insulating layer 140 including silicon nitride (SiNx) or silicon oxide (SiOx) is disposed on the gate conductor 121. The gate insulating layer 140 may have a multilayer structure including at least two insulating layers with different physical properties, or may have a single layer structure.

A semiconductor 154 including amorphous silicon or polysilicon is disposed on the gate insulating layer 140. The semiconductor 154 may include an oxide semiconductor.

Ohmic contacts 163 and 165 are disposed on the semiconductor 154. The ohmic contacts 163 and 165 may include a material such as n+ hydrogenated amorphous silicon in which an n-type impurity such as phosphorus is doped at a high concentration, or a silicide. The ohmic contacts 163 and 165 may collectively form a pair of ohmic contacts to be disposed on the semiconductor 154. When the semiconductor 154 is an oxide semiconductor, the ohmic contacts 163 and 165 may be omitted.

A data conductor including a data line 171, a source electrode 173 and a drain electrode 175 is disposed on the ohmic contacts 163 and 165 and on the gate insulating layer 140.

The data line 171 includes a wide end portion (not shown) for contact with another layer or an external driving circuit. The data line 171 transmits a data signal and is mainly extended to be elongated in a direction perpendicular to an extension direction of the gate line 121 so as to cross the gate line 121.

The data line 171 may have a first curved portion inclined with respect to an extension direction of the gate line 121 to obtain maximum transmittance of the liquid crystal display. First curved portions may meet each other at an intermediate region of the pixel area to form a “V” shape. The data line may further include a second curved portion that is extended from the first curved portion to form a predetermined angle with the first curved portion.

The source electrode 173 is a portion of the data line 171 and is disposed on the same extension line as the data line 171. The source electrode 173 may have a width taken perpendicular to the extension line, larger than that of an adjacent portion of the data line 171. The drain electrode 175 includes a portion which is elongated to be parallel with an extension direction of the source electrode 173. Therefore, the drain electrode 175 is parallel with a portion of the data line 171.

The gate electrode 124, the source electrode 173 and the drain electrode 175 collectively form a single thin film transistor (TFT) together with the semiconductor 154. A channel of the thin film transistor is defined by a portion of the semiconductor 154 which is exposed between the source electrode 173 and the drain electrode 175.

The exemplary embodiment of the liquid crystal display according to the invention includes the source electrode 173 positioned on the same extension line as that of the data line 171 and the drain electrode 175 extending parallel to the data line 171 so that the width of the thin film transistor may be increased without increasing an overall area of the data conductor, thereby increasing the aperture ratio of the liquid crystal display.

The data line 171 and the drain electrode 175 may include a refractory metal such as molybdenum, chromium, tantalum, titanium, or an alloy thereof. The data line 171 and the drain electrode 175 may have a multilayer structure including a refractory metal layer (not shown) and a low resistance conductive layer (not shown). An example of the multilayered structure may include a double layer including a chromium or molybdenum (alloy) lower layer and an aluminum (alloy) upper layer, and a triple layer including a molybdenum (alloy) lower layer, an aluminum (alloy) intermediate layer, and a molybdenum (alloy) upper layer.

A first passivation layer 180a is disposed on the data conductors 171, 173 and 175, the gate insulating layer 140, and the exposed portion of the semiconductor 154. The first passivation layer 180a may include an organic insulating material and/or an inorganic insulating material.

A color filter 230 is disposed on the first passivation layer 180a.

The color filter 230 can uniquely express one among a plurality of primary colors which exemplarily include red, green and blue, or yellow, cyan and magenta. Although not shown, a collective color filter may further include a plurality of individual color filters for displaying mixed colors of the primary colors, or white. An additional overcoat (not shown) may be disposed on the color filter 230.

A common electrode 270 is disposed on the color filter 230. The common electrode 270 is a first field generating electrode in the liquid crystal display. The common electrode 270 with a planar shape may be disposed on an entirety of the first substrate 110 as a whole plate, and an opening 138 may be defined in the common electrode 270 at a region corresponding to a periphery of the drain electrode 175. That is, the common electrode 270 can have a plate-type plane form.

Common electrodes 270 provided in adjacent pixel areas are connected to each other, and receive a predetermined common voltage supplied from outside of the display area of the liquid crystal display.

A second passivation layer 180b is disposed on the common electrode 270. The second passivation layer 180b may include an organic insulating material and/or an inorganic insulating material.

A pixel electrode 191 is disposed on the second passivation layer 180b. The pixel electrode 191 includes a curved edge that is substantially parallel with the first curved portion and the second curved portion of the data line 171. A plurality of first cutouts 91 is defined in the pixel electrode 191, and the plurality of first cutouts 91 define a plurality of first branch electrodes 192 of the pixel electrode 191.

A first contact hole 185 exposing the drain electrode 175 is defined in the first passivation layer 180a and the second passivation layer 180b. In an exemplary embodiment of manufacturing the liquid crystal display, a color filter material disposed on the first substrate 110 and corresponding to a position where the first contact hole 185 will be formed is removed to provide the color filter 230.

The first light blocking member 220 and the second light blocking member 320 are disposed on the second passivation layer 180b and overlap the pixel electrode 191. The first light blocking member 220 is disposed elongated to overlap the data line 171, and the second light blocking member 320 is disposed elongated to overlap the gate line 121 and the contact hole 185. The first light blocking member 220 and the second light blocking member 320 may be disposed in a same layer or different layers of the liquid crystal display, and portions thereof can overlap each other. The second light blocking member 320 includes the light blocking extension 320A disposed at a position overlapping the spacer 325.

The spacer 325 is disposed at a position overlapping the light blocking extension 320A of the second light blocking member 320. The spacer 325 may be disposed in a same layer as the second light blocking member 320 in on a different layer from the second light blocking member 320. In an exemplary embodiment of manufacturing the liquid crystal display, the spacer 325 and the second light blocking member 320 may be formed from a same material to be disposed in the same layer or in different layers of the liquid crystal display.

The spacer 325 maintains a gap between the lower display panel 100 and the upper display panel 200.

A first alignment layer 11 is disposed on the pixel electrode 191 and the spacer 325.

The upper display panel 200 will now be described.

A second alignment layer 21 is disposed on a second substrate 210 including transparent glass or plastic.

The first alignment layer 11 and the second alignment layer 21 are initially aligned in the alignment direction (R) of FIG. 1.

A liquid crystal layer 3 includes a liquid crystal material having positive dielectric anisotropy or negative dielectric anisotropy.

A long-axis direction of the liquid crystal molecules of the liquid crystal layer 3 are disposed in parallel to the display panels 100 and 200.

According to the exemplary embodiment of the liquid crystal display in FIG. 1 to FIG. 5, the common electrode 270 has a plane form in a planar shape and the pixel electrode 191 includes a plurality of branch electrodes, but the invention is not limited thereto. In another exemplary embodiment of the liquid crystal display according to the invention, the pixel electrode 191 has a plane form in a planar shape and the common electrode 270 includes a plurality of branch electrodes defined by a plurality of cutouts.

One or more exemplary embodiment of the invention is applicable to any of various display devices in which two field generating electrodes overlap each other with an insulating layer therebetween and are disposed on a single substrate of a display panel, the first field generating electrode disposed below the insulating layer has a plane form in a planar shape, and the second field generating electrode disposed above the insulating layer has a plurality of branch electrodes.

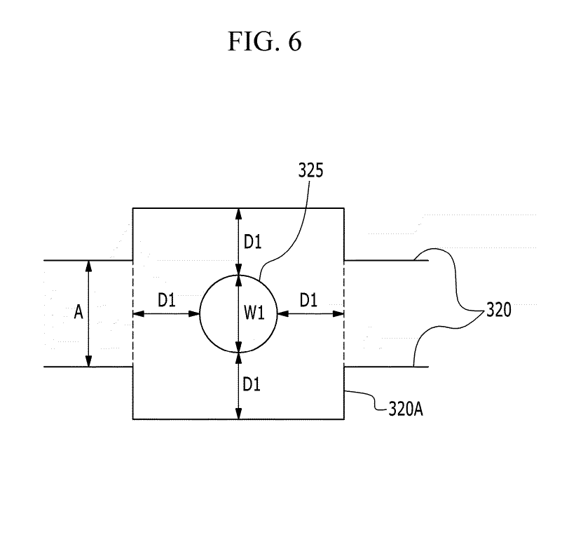

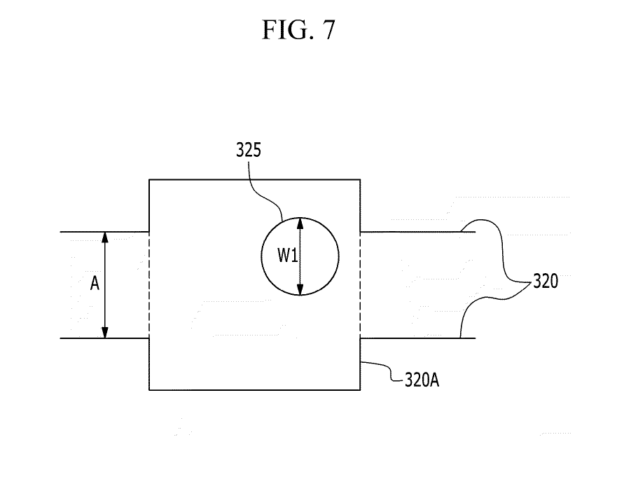

A light blocking extension and a spacer of a liquid crystal display according to the invention will now be described with reference to FIG. 6 and FIG. 7. FIG. 6 and FIG. 7 are plan views which respectively show exemplary embodiments of a light blocking extension with respect to a spacer of a liquid crystal display according to the invention.

Referring to FIG. 6, in a direction perpendicular to an extension direction of the second light blocking member 320, the light blocking extension 320A is wider than a first width (A) of an adjacent portion of the second light blocking member 320. A width of a remaining portion of the second light blocking member 320 other than the light blocking extension 320A may be the first width (A). The light blocking extension 320A has a substantially quadrangular form including two first sides that are parallel to a direction in which the second light blocking member 320 and the gate line 121 are elongated, and two second sides that are orthogonal to the first sides. A second side of the light blocking extension 320A is substantially parallel to the alignment direction (R).

The first sides and the second sides of the light blocking extension 320A are longer than a maximum width W1 of the spacer 325. FIG. 6 shows an exemplary embodiment in which the light blocking extension 320A and the spacer 325 are aligned, and a minimum distance D1 is defined between the first side and the second side of the light blocking extension 320A, and an outer edge of the spacer 325. The minimum distance D1 may be substantially about 9 micrometers (μm). As illustrated in FIG. 6, an entirety of the spacer 325 is overlapped by the light blocking extension 320A. Alignment of the light blocking extension 320A and the spacer 325 may be defined as an exemplary embodiment in which planar centers of the light blocking extension 320A and the spacer 325 coincide with each other.

FIG. 7 shows an exemplary embodiment in which the light blocking extension 320A and the spacer 325 are misaligned, and the first side and the second side of the light blocking extension 320A are longer than the maximum width W1 of the spacer 325. Even when the light blocking extension 320A and the spacer 325 are misaligned, the light blocking extension 320A overlaps the spacer 325. As illustrated in FIG. 7, an entirety of the spacer 325 is overlapped by the light blocking extension 320A. Misalignment of the light blocking extension 320A and the spacer 325 may be defined as an exemplary embodiment in which planar centers of the light blocking extension 320A and the spacer 325 do not coincide with each other.

As described, when the light blocking extension 320A and the spacer 325 are misaligned, leakage of light that may occur around the spacer 325 can be reduced or effectively prevented by overlapping the light blocking extension 320A and the spacer 325.

Also, the light blocking extension 320A includes a side that is substantially parallel to the alignment direction (R) such that the liquid crystal molecules are not elongated to be inclined (e.g., diagonal) with respect to the alignment direction (R) due to a step of the light blocking extension 320A.

When the liquid crystal molecules are elongated to be inclined (e.g., diagonal) with respect to the alignment direction (R) due to a step of the light blocking extension 320A, rotation of the inclined liquid crystal molecules from their initial alignment in a desired direction may be difficult such that light may leak around the inclined liquid crystal molecules.

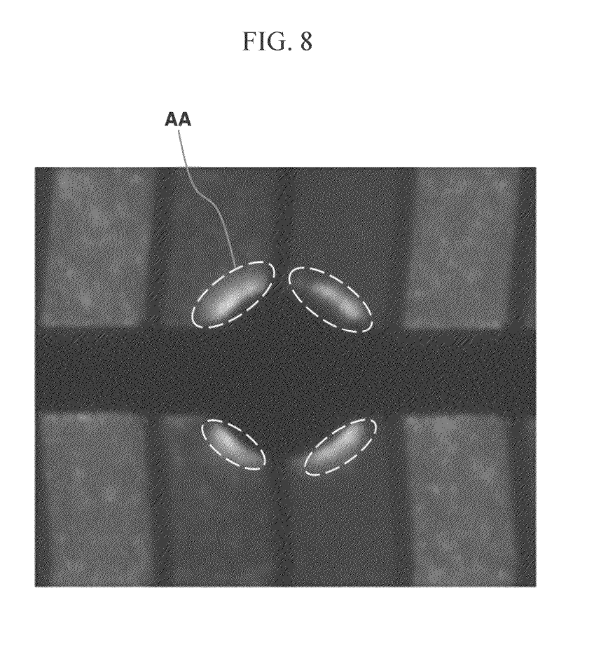

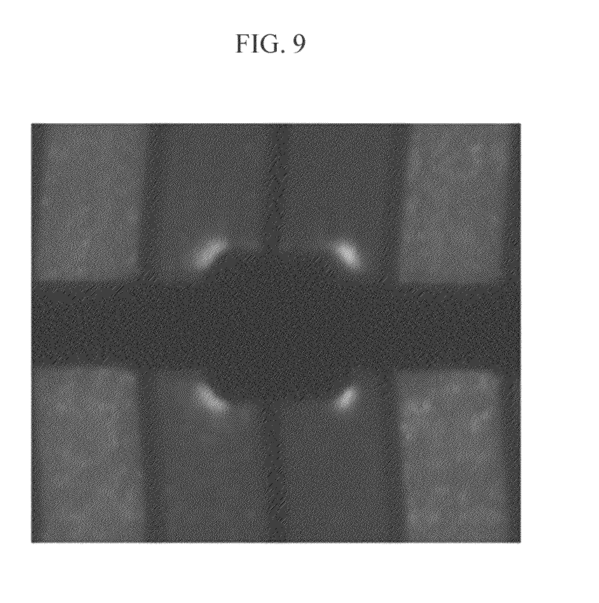

An experimental examples will now be described with reference to FIG. 8 and FIG. 9. FIG. 8 and FIG. 9 are scanning electron microscope photographs respectively showing a result of experimental examples of light leakage in a conventional liquid crystal display and in an exemplary embodiment of liquid crystal display according to the invention.

In the experimental examples, leakage of light occurring around a spacer lo is measured for a first case in which the light blocking extension of a conventional liquid crystal display has a circular or oval plane form, and a second case in which the light blocking extension of an exemplary embodiment of a liquid crystal display according to the invention has a substantially quadrangular plane form where two sides of the light blocking extension are substantially parallel to the alignment direction. Corresponding results are shown with the scanning electron microscope photographs of FIG. 8 and FIG. 9. FIG. 8 shows a result for the first case of the conventional liquid crystal display, and FIG. 9 shows a result for the second case of the exemplary embodiment of the liquid crystal display according to the invention. In the first case and the second case, all conditions except the plane form of the light blocking extension are the same.

Referring to FIG. 8, regarding the liquid crystal display for the first case, light is found to leak around the light blocking extension. Particularly, much light is found to leak from a portion (AA) that is disposed at intersecting edges of the light blocking extension. The light leaking portion (AA) is elongated to be inclined (e.g., diagonal) with respect to the alignment direction (R). That is, the liquid crystal molecules at the portion (AA) are irregularly arranged due to the step difference of the light blocking extension, such that in the portion (AA) that is extended inclined with respect to the alignment direction (R), light is accordingly leaked.

Referring to FIG. 9, compared to the first case, leakage of light occurring at edges of the light blocking extension of the exemplary embodiment of the liquid crystal display according to the invention is very much reduced according to that in the conventional liquid crystal display of the second case.

One or more exemplary embodiment of the invention is applicable to any of various display devices in which two field generating electrodes overlap each other with an insulating layer therebetween and are disposed on a single substrate of a display panel, the first field generating electrode disposed below the insulating layer has a plane form in a planar shape, and the second field generating electrode disposed above the insulating layer includes a plurality of branch electrodes.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A liquid crystal display comprising:
a first substrate;
a gate line and a data line on the first substrate;
a first electrode and a second electrode on the first substrate and overlapping each other;
a first insulating layer between the first electrode and the second electrode;
a light blocking extension on the first substrate;
a spacer on the light blocking extension; and
a first alignment layer on the spacer and having an alignment direction,
wherein
a plane form of the light blocking extension includes a side elongated parallel to the first alignment layer alignment direction.

2. The liquid crystal display of claim 1, wherein
the light blocking extension has a quadrangular plane form.

3. The liquid crystal display of claim 2, further comprising a plurality of pixel areas,
wherein
the light blocking extension is extended to overlap four adjacent pixel areas.

4. The liquid crystal display of claim 3, wherein
the light blocking extension overlaps a red pixel area and a blue pixel area.

5. The liquid crystal display of claim 2, further comprising
a first light blocking member and a second light blocking member on the first substrate,
wherein
the first light blocking member is elongated to overlap the data line, and
the second light blocking member is elongated to overlap the gate line.

6. The liquid crystal display of claim 5, wherein
the second light blocking member comprises the light blocking extension.

7. The liquid crystal display of claim 2, wherein
the light blocking extension is wider than a maximum dimension of the spacer.

8. The liquid crystal display of claim 2, further comprising
a color filter between the first substrate and the first electrode, and between the first substrate and the second electrode.

9. The liquid crystal display of claim 2, further comprising a plurality of pixel areas,
wherein
the first electrode has a planar shape in a pixel area,
the second electrode includes a plurality of branch electrodes in the pixel area, and
in the pixel area, the second electrode branch electrodes overlap the planar shape first electrode.

10. The liquid crystal display of claim 1, further comprising a plurality of pixel areas,
wherein
the light blocking extension is extended to overlap four adjacent pixel areas.

11. The liquid crystal display of claim 10, wherein
the light blocking extension overlaps a red pixel area and a blue pixel area.

12. The liquid crystal display of claim 1, further comprising
a first light blocking member and a second light blocking member on the first substrate,
wherein
the first light blocking member is elongated to overlap the data line, and
the second light blocking member is elongated to overlap the gate line.

13. The liquid crystal display of claim 12, wherein
second light blocking member comprises the light blocking extension.

14. The liquid crystal display of claim 1, wherein
the light blocking extension is wider than a maximum dimension of the spacer.

15. The liquid crystal display of claim 1, further comprising
a color filter between the first substrate and the first electrode, and between the first substrate and the second electrode.

16. The liquid crystal display of claim 1, further comprising a plurality of pixel areas,
wherein
the first electrode has a planar shape in a pixel area,
the second electrode includes a plurality of branch electrodes in the pixel area, and
in the pixel area, the second electrode branch electrodes overlap the planar shape first electrode.

17. The liquid crystal display of claim 13, wherein an entirety of the spacer is overlapped by the light blocking extension.

18. The liquid crystal display of claim 1, further comprising a thin film transistor connected to the gate line and the data line,
wherein
the light blocking extension overlaps the thin film transistor.
